(19) United States
(12) Patent Application Publication
(10) Pub. No.: US 2003/0215700 A1
(43) Pub. Date: Nov. 20, 2003

(54) Nonaqueous electrolyte secondary battery

(76) Inventors: Kenichiro Hosoda, Fukushima (JP); Yoshihiro Dokko, Fukushima (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/405,443

(22) Filed: Apr. 2, 2003

(30) Foreign Application Priority Data
Apr. 4, 2002 (JP) JP2002-102982
Apr. 17, 2002 (JP) JP2002-115368

(51) Int. Cl. H01M 2/00; H01M 2/18

(52) U.S. Cl. 429/94; 429/163; 429/130

(57) ABSTRACT

A nonaqueous electrolyte secondary battery includes a wound electrode body structured by spirally winding electrodes with a separator in between, the electrode having a strip shape and being formed by forming a mixture layer on a current collector having a strip shape, a hollow cylindrical center pin that is inserted into a center hole of the wound electrode body, and a battery can, in which the wound electrode body having the center pin inserted therein is stored. The center pin is formed in such a way that the center pin does not crash by a force equal to 34N or less.

### RELATED APPLICATION DATA

This application claims priority to Japanese Patent Application JP 2002-102982 filed on Apr. 4, 2002 and 2002-115368 filed on Apr. 17, 2002, and the disclosures of these applications are incorporated herein by reference to the extent permitted by law.

### BACKGROUND OF THE INVENTION

1. Field of the Invention

The present invention relates to a nonaqueous electrolyte secondary batter in which a wound electrode body is contained in a battery can and the wound electrode body is constructed by spirally winding a strip of positive electrode and a strip of negative electrode with a separator placed in between.

2. Description of the Related Art

Typically, such a type of a nonaqueous electrolyte secondary battery described above is configured to include a wound electrode body that is spirally wound, a center pin that is inserted into a center hole of the wound electrode body, a battery can for storing the wound electrode body in which the center pin is inserted, and a terminal plate or the like to close an opening of the battery can. The wound electrode body has a positive electrode and a negative electrode that are formed in a strip shape, and a separator that is also formed in a strip shape as same as these electrodes. These structural elements are overlaid in the order of the negative electrode, the separator, the positive electrode and the separator.

By winding such a multi-layered body, in which these four layers of these structural elements are overlaid, for the appropriate number of times, the wound electrode body that is wound spirally as a whole is constructed. A hollow cylindrical center pin is inserted into a center hole of the wound electrode body. A main purpose of the center pin is to constrain deformation of the electrode that is expanded due to overcharge or the like of the wound electrode body and to prevent a short circuit (internal short circuit) of the positive electrode and the negative electrode due to the deformation. As another purpose, the center pin also serves as a means for letting gas, which is generated in a bottom portion of the battery can, out through a center hole of the pin to the upside of the wound electrode body.

The center pin is stored inside of the battery can together with the wound electrode body and the opening of the battery can is closed by the terminal plate through a gasket. By crimping the opening of the battery can together with the gasket, a nonaqueous electrolyte secondary battery that is sealed by the terminal plate or the like is constructed. Thus, by providing the center pin in an integrated fashion with the wound electrode body, it is possible to prevent the deformation of the wound electrode body or to effectively inhibit the deformation against pressure increase inside of the battery can.

In recent years, with technical advancements of electronics devices such as a personal computer, a tape recorder, a CD player, a camera combo VTR and an electronic still camera or the like, larger capacity and higher output are desired for a battery, which serves as an energy pack of such electronics devices. Particularly, with respect to a secondary battery that is rechargeable and may be used repeatedly, it is desirable to have larger capacity and higher output, in view of economical efficiency of recycling usage, convenience in handling, and the like.

### SUMMARY OF THE INVENTION

The above described conventional nonaqueous electrolyte secondary battery is constructed in such a manner that the center pin is inserted into the center hole of the wound electrode body and the center pin serves to prevent the crush of the wound electrode body in order to prevent the wound electrode body from being crushed due to the pressure increase inside of the battery can. However, the conventional center pin is heavy and its outer diameter is large. Therefore, it is problematic since the entire weight of the battery becomes heavier with such conventional center pin, thereby making it difficult to sufficiently increase the capacity and the output thereof.

The present invention has been made taking the foregoing problems into consideration. A first object of the present invention is to provide a nonaqueous electrolyte secondary battery with less weight but higher capacity and output by decreasing an outer diameter thereof as much as possible while securing functions of preventing the crush of a wound electrode body and draining the gas. These functions required for a center pin of the nonaqueous electrolyte secondary battery.

In a first aspect of the present invention, a nonaqueous electrolyte secondary battery is provided. The nonaqueous electrolyte secondary battery includes; a wound electrode body that is structured by spirally winding electrodes with a separator in between, the electrode having a strip shape and being formed by forming a mixture layer on a current collector having a strip shape; a hollow cylindrical center pin that is inserted into a center hole of the wound electrode body; and a battery can, in which the wound electrode body having the center pin inserted therein is stored. In the present aspect, the center pin is formed to have a strength in such a way that the center pin does not crash by a force equal to 34N or less.

In a second aspect of a nonaqueous electrolyte secondary battery according to the present invention, the electrode may include a positive electrode, in which a positive-electrode mixture layer is formed on a positive-electrode current collector; and a negative electrode, in which a negative-electrode mixture layer is formed on a negative-electrode current collector and stacked on the positive electrode with having the separator in between; and an end portion of the separator at an outer circumference side in a winding direction is elongated further than the positive electrode and the negative electrode, thereby preventing the positive electrode or the negative electrode locating at the outermost circumference to contact an inner surface of the battery can.

In a third aspect of a nonaqueous electrolyte secondary battery according to the present invention, the electrode may include a positive electrode, in which a positive-electrode mixture layer is formed on a positive-electrode current collector; and a negative electrode, in which a negative-electrode mixture layer is formed on a negative-electrode current collector and stacked on the positive electrode having the separator in between; and an end portion of the separator at an inner circumference side in a winding direction is elongated further than the positive electrode and the negative electrode, thereby preventing the positive electrode or the negative electrode locating at the innermost circumference to contact the inner surface of the center pin.

In a fourth aspect of a nonaqueous electrolyte secondary battery according to the present invention, the electrode may include a positive electrode, in which a positive-electrode mixture layer is formed on a positive-electrode current collector; and a negative electrode, in which a negative-electrode mixture layer is formed on a negative-electrode current collector and stacked on the positive electrode having the separator in between; and the positive electrode and the negative electrode are formed to be substantially the same length, and the negative electrode is placed to be outside of the positive electrode so as that the end portion of the negative electrode at the outer circumference side in the winding direction contacts an inner surface of the battery can.

In a fifth aspect of a nonaqueous electrolyte secondary battery according to the present invention, the electrode may include a positive electrode, in which a positive-electrode mixture layer is formed on a positive-electrode current collector; and a negative electrode, in which a negative-electrode mixture layer is formed on a negative-electrode current collector and stacked on the positive electrode having the separator in between; and the positive electrode is placed to be at the inner side of the negative electrode, and the end portion of the positive-electrode current collector at the inner circumference side in the winding direction is elongated so that a portion in which the positive-electrode mixture layer is not formed contacts an outer surface of the center pin.

Further, in the aspects of present invention described above, a ratio among an outer diameter of the wound electrode body, an inner diameter of the battery can and an outer diameter of the center pin may be 0.97:1:0.2 to 0.96:1:0.13, and a ratio between an inner diameter of the wound electrode body and the outer diameter of said center pin may be 1:0.95 to 1:0.79.

In a sixth aspect of a nonaqueous electrolyte secondary battery according to the present invention, the center pin may be formed with a material, of which Young's modulus of the center pin at a temperature more than 600° C. is equal to 100,000 N/mm² or larger.

According to the nonaqueous electrolyte secondary battery that is constructed according to the first aspect of the present invention, even if, with an increase of a temperature inside of the battery can due to the overcharge or the like, a pressure inside of the battery can increases and fastening force being applied onto the center pin by the wound electrode body increases, it is possible to prevent or inhibit occurrence of the internal short circuit at the end portion at the inner circumference side of the wound electrode body and to improve safety thereof since the center pin is configured so as not to crushed by a force equal to 34 N (Newton) or less.

According to the nonaqueous electrolyte secondary battery according to the second aspect of the present invention, the end portion of the separator contacts the inner surface of the battery can, but the positive electrode or the negative electrode locating at the outermost circumference does not contact the inner surface of the battery can. Accordingly, it is possible to prevent the occurrence of the internal short circuit by securing the insulation between the positive electrode and the negative electrode.

According to the nonaqueous electrolyte secondary battery according to the third aspect of the present invention, the end portion of the separator contacts the outer surface of the center pin, but the positive electrode or the negative electrode locating at the innermost circumference does not contact the inner surface of the battery can. Accordingly, it is possible to prevent the occurrence of the internal short circuit by securing the insulation between the positive electrode and the negative electrode.

According to the nonaqueous electrolyte secondary battery according to the fourth aspect of the present invention, the end portion at the outer circumference side in a winding direction of the negative electrode contacts the inner surface of the battery can, so that it is possible to effectively use the battery can as a negative electrode.

According to the nonaqueous electrolyte secondary battery according to the fifth aspect of the present invention, the end portion at the inner circumference side of a positive-electrode current collector of the positive electrode contacts the outer surface of the center pin, so that it is possible to effectively use the center pin as a positive electrode.

According to the nonaqueous electrolyte secondary battery according to the sixth aspect of the present invention, the Young's modulus of the center pin is equal to 100,000 N/mm² or larger at a temperature more than 600° C. Accordingly, even if the temperature inside of the battery can becomes abnormally high, it is possible to prevent the deformation of the wound electrode body and to keep its body's integrity.

Furthermore, a conventional type of the conventional nonaqueous electrolyte secondary battery is provided with a wound electrode body that is spirally wound, a battery can to store the wound electrode body, and a terminal plate to close an opening of the battery can or the like. The wound electrode body has a positive electrode and a negative electrode that are formed in a strip shape, and a separator that is also formed in a strip shape as same as these electrodes. These constructional elements are overlaid in an order of the negative electrode, the separator, the positive electrode and the separator. By winding a multi-layered body in which four layers of these constructional elements described above are overlaid, for the appropriate number of times, the wound electrode body that is wound spirally as a whole is constructed.

However, in such conventional nonaqueous electrolyte secondary battery, a mixture layer is formed up to a vicinity of an end portion of the outer circumference side in a winding direction of a current collector. If an abnormal circumstance such that the battery can is crushed occurs, and if the end portion at the outer circumference side of the negative electrode break through the separator, its front end may come into contact with the mixture layer of the adjacent positive electrode. It would cause a problem if the negative electrode and the positive electrode are connected and the internal short circuit (short circuit) occurs.

The present invention has been made taking the foregoing problems into consideration. A second object of present invention, besides the first object of present invention described above, is to provide a nonaqueous electrolyte secondary battery that is capable of preventing or effectively inhibiting the occurrence of the internal short circuit. It is desirable to provide a nonaqueous electrolyte secondary battery configured in such a way that the same type of electrodes would come into contact with each other even if the electrode break through the separator and contact to the adjacent electrode. Furthermore, it is desirable to provide a nonaqueous electrolyte secondary battery with an exposed portion of the current collector in which, at the end portion in the winding direction of the electrode, the mixture layer is not formed over a range at least one lap from the foregoing end portion.

In a seventh aspect of the present invention, a nonaqueous electrolyte secondary battery is provided. The nonaqueous electrolyte secondary battery includes: a wound electrode body that is structured by spirally winding electrodes with a separator in between, the electrode having a strip shape and being formed by forming mixture layers on both sides of a current collector having a strip shape; and a battery can, in which the wound electrode body is stored. In the present aspect, the wound electrode body further includes a current collector exposed portion in which the mixture layers are not formed on neither side of the surfaces of the current collector, the current collector exposed portion being provided to start at the end portion of the electrode at the outer circumference side in the winding direction and extend over a range of at least one lap from an end portion of the current collector having the mixture layers on both sides.

In an eighth aspect of a nonaqueous electrolyte secondary battery according to present invention, the electrode may include a positive electrode, in which a positive-electrode mixture layer is formed on a positive-electrode current collector; and a negative electrode, in which a negative-electrode mixture layer is formed on a negative-electrode current collector and stacked on the positive electrode having the separator in between; and the negative electrode is placed to be at the outside of the positive electrode, and an end portion of the negative-electrode current collector is elongated further than an end portion of the positive-electrode current collector.

In a ninth aspect of a nonaqueous electrolyte secondary battery according to present invention, a length of the current collector exposed portion may be equal to πd or larger, where an outer diameter of the wound electrode body is defined as d.

In a tenth aspect of a nonaqueous electrolyte secondary battery according to present invention, a center pin formed as a hollow cylinder may be inserted in a winding center portion of the wound electrode body.

In an eleventh aspect of a nonaqueous electrolyte secondary battery according to present invention, the center pin may be formed to have a strength in such a way that the center pin does not crush by a force equal to 34N or less.

In a twelfth aspect of a nonaqueous electrolyte secondary battery according to present invention, a ratio among an outer diameter of the wound electrode body, an inner diameter of the battery can and an outer diameter of the center pin may be 0.97:1:0.2 to 0.96:1 0.13, and a ratio between an inner diameter of the wound electrode body and the outer diameter of the center pin may be 1:0.95 to 1:0.79.

In a thirteenth aspect of a nonaqueous electrolyte secondary battery according to present invention, an electrode density of the positive electrode may be 3.40 to 3.60 g/cm³, and an electrode density of the negative electrode may be 1.55 to 1.80 g/cm³.

According to the nonaqueous electrolyte secondary battery according to the seventh aspect of the present invention, even if the front end of the current collector of the electrode locating at the outermost circumference breaks through the separator and comes into contact with the current collector of the electrode locating inside due to the deformation of the battery when it is depressed, the current collectors of the same electrode type would contact to each other. As a result, the internal short circuit may be prevented, and it is possible to prevent the occurrence of a malfunction due to the internal short circuit.

According to the nonaqueous electrolyte secondary battery according to the eighth aspect of the present invention, even if the front end of the negative-electrode current collector of the negative electrode locating at the outermost circumference breaks through the separator and come into contact with the negative-electrode current collector locating inside due to the deformation of the battery when it is depressed, the current collectors of the same negative electrode type would contact to each other. As a result, the internal short circuit may be prevented, and it is possible to prevent the occurrence of a malfunction due to the internal short circuit. In addition, even if the front end of the current collector of the positive electrode locating at the second layer, which is counted from the outside, breaks through the separator and comes into contact with the negative-electrode current collector locating inside, the short circuit would occurs at a place away from the mixture layer. As a result, it is possible to enhance the diffusion of heat that is generated by the foregoing short circuit and to make the impact of the short circuit smaller as compared to a case where the short circuit is occurred at a part where the mixture layer is formed.

According to the nonaqueous electrolyte secondary battery according to the ninth aspect of the present invention, the end portion of the outer circumference side of the current collector may be exposed over one lap or longer by making the length of the exposed portion of the current collector π times of a diameter d of the wound electrode body. Accordingly, even if the front end of the current collector of the electrode locating at the outermost circumference bursts through the separator and comes into contact with the current collector of the electrode locating inside due to the deformation of the battery when it is depressed, the current collectors of the same electrode type would contact to each other. As a result, the internal short circuit may be prevented, and it is possible to prevent the occurrence of a malfunction due to the internal short circuit.

According to the nonaqueous electrolyte secondary battery according to the tenth aspect of the present invention, even if the battery is depressed and deformed, it is possible to prevent or suppress the deformation of the wound electrode body with the center pin and to direct the wound electrode body so as to expand only to the outer direction.

According to the nonaqueous electrolyte secondary battery according to the twelfth aspect of the present invention, by setting a measurement relation among the wound electrode body, the battery can and the center pin within the above described range, it is possible to secure an ability to circulate gas generated within the battery without decreasing the battery capacity.

According to the nonaqueous electrolyte secondary battery according to the thirteenth aspect of the present invention, by setting a positive-electrode active material of a positive-electrode mixture and a negative-electrode active material of a negative-electrode mixture within the above described range, it is possible to increase the battery capacity and to improve its electric energy.

### BRIEF DESCRIPTION OF THE DRAWINGS

The features and advantages of the present invention will become more apparent in the following description of the presently preferred exemplary embodiments of the invention taken in conjunction with the accompanying drawings, in which:

FIG. 1 is a longitudinal sectional view for showing an embodiment of a nonaqueous electrolyte secondary battery according to the present invention.

FIG. 2 is a perspective view for showing an embodiment of a wound electrode body according to the nonaqueous electrolyte secondary battery of the present invention;

FIG. 3 is an explanatory view, in which an embodiment of the wound electrode body according to the nonaqueous electrolyte secondary battery of the present invention is cut in a lateral direction.

FIG. 4 is an explanatory view for explaining a measurement relation among a battery can, a wound electrode body and a center pin according to an embodiment of the nonaqueous electrolyte secondary battery according to the present invention.

FIG. 5 is an explanatory view for showing an embodiment of the nonaqueous electrolyte secondary battery according to the present invention, in which a center portion of the nonaqueous electrolyte secondary battery is cut in a longitudinal direction.

FIG. 6 is a perspective view for showing an external view of the wound electrode body according to an embodiment of the nonaqueous electrolyte secondary battery according to the present invention.

FIG. 7 is an explanatory view, in which the wound electrode body according to an embodiment of the nonaqueous electrolyte secondary battery of the present invention is cut in a lateral direction.

FIG. 8 is an explanatory view for explaining a measurement relation among the battery can, the wound electrode body and the center pin according to an embodiment of the nonaqueous electrolyte secondary battery according to the present invention.

FIG. 9 is an explanatory view, in which an embodiment of the wound electrode body according to the nonaqueous electrolyte secondary battery of the present invention is cut in a lateral direction.

### DESCRIPTION OF THE PREFERRED EMBODIMENTS

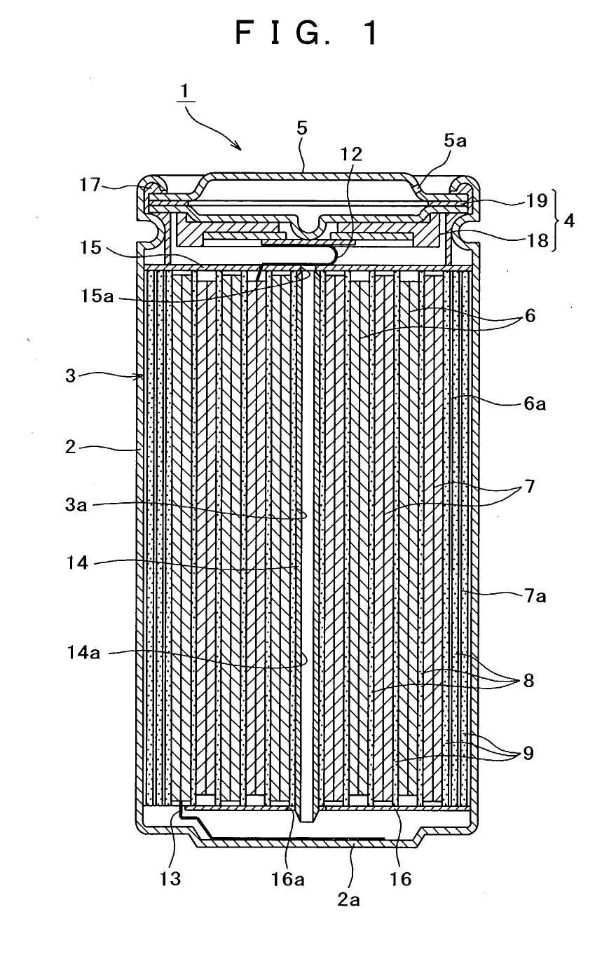

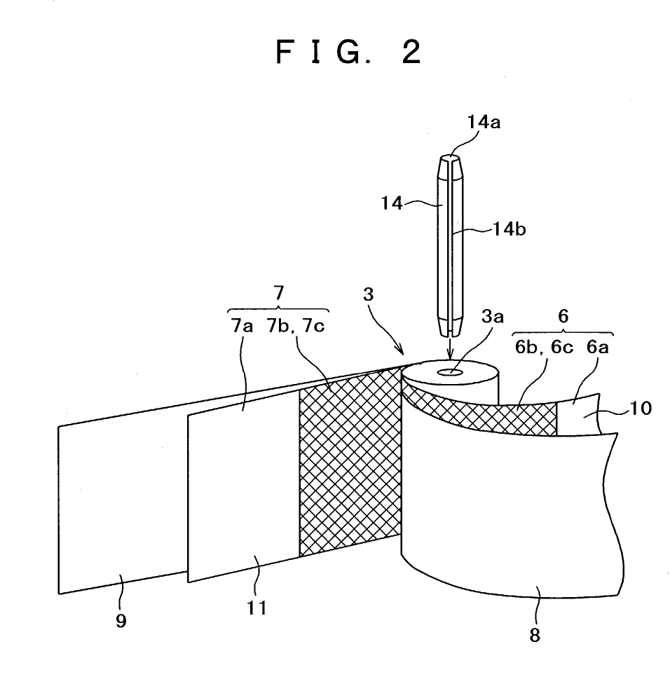

A first embodiment of the present invention will be described below with reference to FIGS. 1 to 4.

As a nonaqueous electrolyte secondary battery according to the present invention, for example, a lithium-ion secondary battery may be used. FIG. 1 is a longitudinal sectional view for showing a center portion of the lithium-ion secondary battery. As shown in FIG. 1, a lithium-ion secondary battery 1, which is the first embodiment of the nonaqueous electrolyte secondary battery according to the present invention, may include a cylindrical battery can 2, a cylindrical wound electrode body 3 that is stored inside of the battery can 2, a safety valve device 4 for preventing abnormal pressure increase and overcharge within the battery, and a terminal plate 5 to close an opening of the battery can 2.

The battery can 2 is formed as a hollow and cylindrical body with a bottom, for example, by a metal having conductivity such as Fe or the like. At the bottom of the battery can 2, a terminal portion 2a is disposed as a result that the center portion thereof is expanded in a circle slightly to the outside. It is preferable that an inner face of the battery can 2 is constructed so as to increase conductivity of the battery can 2, for example, by applying nickel plate thereto or applying an electrically conductive coating thereto. In addition, for example, an outer circumferential surface of the battery can 2 is protected with being covered with an exterior label that is made of a plastic sheet and a paper or the like or applied with an insulative coating.

The wound electrode body 3 that is stored inside of the battery can 2 has a structure as shown in FIGS. 1 to 3. In other words, the wound electrode body 3 is provided with a positive electrode 6 and a negative electrode 7 that are formed in a strip shape, and two separators 8 and 9 that are also formed in a strip shape as same as these electrodes. One separator 8 is placed between the positive electrode 6 and the negative electrode 7, and the other separator 9 is arranged to be placed at the opposite side of the separator 8 over the positive electrode 6. The wound electrode body 3 that is wound spirally is constructed by winding a multi-layered body in which four layers of these structural elements described above are overlaid while placing the positive electrode 6 at the inner side.

The positive electrode 6 is constructed with a positive-electrode current collector 6a that is formed in a strip shape and positive-electrode mixture layers 6b, 6c that are applied on both sides of the positive-electrode current collector 6a. As the positive-electrode current collector 6a, for example, an aluminum foil of thickness 20 μm may be used. By evenly applying a positive-electrode mixture slurry on both sides of the positive-electrode current collector 6a, the positive-electrode mixture layers 6b, 6c are formed.

In this case, at one end (winding end side) in a longitudinal direction of the positive-electrode current collector 6a, a blank portion 10, in which the positive-electrode mixture slurry is not applied across a certain length, is formed. In the same way, at one end (winding end side) in a longitudinal direction of the negative-electrode current collector 7a, a blank portion 11, in which the negative-electrode mixture slurry is not applied across a certain length, is formed.

As a positive-electrode active material of the positive-electrode mixture, the following materials may be used. For example, a chalcogen compound of a transition metal containing an alkali metal, particularly, an oxide of an alkali metal and a transition metal may be used. In addition, as a crystal structure of a chemical compound, a laminated chemical compound and a spinel type chemical compound are frequently used. As the laminated chemical compound, the chemical compound represented as LixMO₂ in a general expression may be used. In this case, Li represents a lithium and O₂ represents an oxygen. Further, x in Lix can be shown by 0.5≦x≦1.10.

In addition, as M, at least one kind of element selected among from the transition metal, specifically, iron (Fe), cobalt (Co), nickel (Ni), manganese (Mn), copper (Cu), zinc (Zn), tin (Sn), chrome (Cr), vanadium (V), and titanium (Ti) or the like may be used. Further, it is preferable that M may include one kind or two kinds or more elements selected from among Fe, Co, Ni, and Mn in these families.

The positive-electrode mixture slurry is produced by use of such a positive-electrode active material. For example, it is possible to produce the positive-electrode mixture slurry in such a manner that the positive-electrode mixture is prepared by mixing a powder LiCoO₂ of 86 weight percent, graphite of 10 weight percent as an electrically conductive agent, and a poly(vinylidene fluoride) of 4 weight percent as a binding agent, and this is diffused into N-methyl-2-pyrrolidone. This positive-electrode mixture slurry is evenly applied on both sides of the positive-electrode current collector 6a so that the blank portion 10 is formed at a winding end portion. Then, the positive-electrode mixture slurry on both sides is dried to be molded with compression by a roller pressing machine, so that the positive electrode 6 is formed in a strip shape.

The negative electrode 7 is constructed by the negative-electrode current collector 7a that is formed in a strip shape as same as the above, and the negative-electrode mixture layers 7b, 7c that are applied on both sides of the negative-electrode current collector 7a. As the negative-electrode current collector 7a, for example, it is possible to use a copper foil of thickness 10 μm. By evenly applying the negative-electrode mixture slurry on both sides of the negative-electrode current collector 7a, the negative-electrode mixture layers 7b and 7c may be formed. In this case, at one end (winding end side) in a longitudinal direction of the negative-electrode current collector 7a, a blank portion 11, in which the negative-electrode mixture slurry is not applied across a certain length, is formed.

A negative-electrode active material of the negative-electrode mixture may be, for example, a negative-electrode active material consisting at least one kind of elements selected from alloys, material capable of being chemically combined, and carbonaceous material, those of which are capable of insertion and extraction of lithium. As the negative-electrode active material capable of insertion and extraction of lithium, for example, metals or semiconductors capable of forming alloys and compounds with lithium, or alloys and compounds of these metals and semiconductors may be used.

These metals, alloys or compounds are, for example, represented as a chemical formula DsEtLiu. In this chemical formula, D may be at least one kind of elements selected from metals and semiconductors capable of forming alloys or compounds with lithium, and alloys and compounds of these metal and semiconductor. In addition, E represents at least one kind of elements selected from metals and semiconductors other than lithium Li and D. Further, values of S, t and u may be set as s>0, t≧0, and u≧0, respectively.

Specifically, as the metal element or the semiconductor element capable of forming an alloy or a compound with lithium, a metal element of 4B group or a semiconductor element is preferable, silicon or tin is more preferable, and silicon is the most preferable. Further, these alloys or compounds thereof are also preferable. Specifically, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂ or ZnSi₂ or the like may be employed.

In addition, as the other example of the negative-electrode active material capable of insertion and extraction of lithium, a carbonaceous material, a metal oxide, or a polymeric material may be also used. As the carbonaceous material, for example, a natural graphite, a nongraphitizable carbon, an artificial graphite, a coke class, a graphite class, a glassy carbon, an organic polymer compound calcined body, a carbon fiber, an activated carbon or a carbon black class or the like may be used. Among these elements, the coke may include a pitch coke, a needle coke or a petroleum coke or the like. In addition, the organic polymer compound calcined body means a polymer member such as a phenol class and a furan class or the like is calcined at an appropriate temperature to be carbonized. Further, as the metal oxide, an iron oxide, a ruthenium oxide, a molybdenum oxide or a tin oxide or the like may be used. In addition, as the polymer material, a polyacetylene or a polypyrrole or the like may be used.

As the nonaqueous electrolyte, a liquid, solid or gel electrolyte or the like may be used, in which the electrolyte is mixed or dissolved in a nonaqueous solvent, a solid electrolyte, a polymer electrolyte and a polymer compound. In this case, as the nonaqueous solvent, for example, a cyclic ester compound such as an ethylene carbonate and a γ-valerolactone or the like, an ether compound such as a diethoxyethane, a tetrahydrofuran, 2-methyltetrahydrofuran, and 1,3-dioxane or the like, a chain-type ester compound such as a methyl acetate, a propylene acid methyl or the like, a chain-type carbonate such as a dimethyl carbonate, a diethyl carbonate, and an ethylmethyl carbonate or the like, or 2,4-difluoroanisole 2,6-difluoroanisole, 4-bromoveratrole or the like may be used solely or as a mixed solvent of two kinds or more.

In addition, as the polymer material to be used for the gel electrolyte, for example, a polyacrylonitrile and a copolymer of a polyacrylonitrile may be used. As a copolymer monomer (vinyl monomer), for example, a vinyl acetate, a methyl methacrylate, a butyl methacrylate, a methyl acrylate, a butyl acrylate, an itaconic acid, a hydrogenated methyl acrylate, a hydrogenated ethyl acrylate, an acrylic amide, a vinyl chloride, vinylidene fluoride, and a vinylidene chloride or the like may be used. Further, an acrylonitrile butadiene rubber, an acrylonitrile butadiene styrene resin, an acrylonitril polyethylene chloride polyethylene propylene diene styrene resin, an acrylonitrile vinyl chloride resin, an acrylonitrile meta acrylate resin, and an acrylonitrile acrylate resin or the like may be used.

Further, as the polymer material to be used for the gel electrolyte, a poly(vinylidene fluoride) and a copolymer of a poly(vinylidene fluoride) may be used. Then, as a copolymer monomer, for example, a hexafluoropropylene and a tetrafluoroethylene or the like may be used. In addition, as the polymer material to be used for the gel electrolyte, the above elements may be used solely or as a mixed solvent of two kinds or more.

In order to form the gel electrolyte layer, as the nonaqueous solvent, for example, a cyclic ester compound such as an ethylene carbonate, a propylene carbonate, a butylene carbonate, a vinylene carbonate, a γ-butyl lactone, and a γ-valerolactone or the like, an ether compound such as a diethoxyethane, a tetrahydrofuran, a 2-methyltetrahydrofuran, and 1,3-dioxane or the like, a chain-type ester compound such as a methyl acetate, a propylene acid methyl or the like, a chain-type carbonate such as a dimethyl carbonate, a diethyl carbonate, and an ethylmethyl carbonate or the like, or 2,4-difluoroanisole, 2,6-difluoroanisole, 4-bromoveratrole or the like may be used solely or as a mixed solvent of two kinds or more.

Further, in the gel electrolyte layer, in the case of using a poly(vinylidene fluoride) as the gel electrolyte, it is preferable that the gel electrolyte composed by a multicomponent system polymer in which a polyhexafluoropropylene and a poly-4-fluorination ethylene or the like are copolymerized is used. This allows to obtain a gel electrolyte having a higher mechanical strength.

In addition, as the electrolyte salt, for example, a lithium salt such as LiPF₆, LiAsF₆, LiBF₄, LiClO₄, LiCF₃SO₃, LiN (CnF₂ₙ₊₁SO₂)₂, LiC₄F₉SO₃ or the like may be used solely or as a mixed solvent of two kinds or more. Further, it is preferable that an addition quantity of the electrolyte salt is prepared so that a molar concentraction of a nonaqueous electrolytic solution in the gel electrolyte is 0.8 to 2.0 mol/l in order to obtain a satisfactory ionic conductance.

The negative-electrode mixture slurry is produced by use of such a negative-electrode active material. For example, it is possible to produce the negative-electrode mixture slurry in such a manner that the negative-electrode mixture is prepared by mixing a graphite material powder of 90 weight percent, and a poly(vinylidene fluoride) of 10 weight percent as a binding agent, and this is diffused into N-methyl-2-pyrrolidone. This negative-electrode mixture slurry is evenly applied on both sides of the negative-electrode current collector 7a so that the blank portion 11 is formed at a winding end portion. Then, the negative-electrode mixture slurry on both sides is dried to be molded with compression by the roller pressing machine, so that the negative electrode 7 is formed in a strip shape.

In addition, as the separators 8 and 9, for example, a polypropylene film with minute porosity may be used. The thickness of these separators 8 and 9 is about 25 μm, and these separators 8 and 9 are placed between the positive electorde 6 and the negative electrode 7. Then, these elements are overlaid in the order of the negative electrode 7, the separator 8, the positive electrode 6 and the separator 9 and wound from one end to the other end. Then, by use of an adhesive tape or the like, an end portion at an outer circumference (winding end side) in the winding direction is fixed. This completes the production of the wound electrode body 3 that is wound spirally.

A density of the above described positive electrode 6 (only for the positive-electrode active material of the positive-electrode mixture layers 6b and 6c) may be within the range of 3.40 to 3.60 g/cm³. In addition, a density of the negative electrode 7 (only for the negative-electrode active material of the negative-electrode mixture layers 7b and 7c) may be within the range of 1.55 to 1.80 g/cm³. By using values within such ranges as the electrode density of the positive electrode 6 and the negative electrode 7, it is possible to increase a reliability of the electrode body 3 and to help its electric energy last longer.

The wound electrode body 3 having such a structure is provided with a plurality of positive electrode leads 12 that are connected to the positive-electrode current collector 6a, and a plurality of negative electrode leads 13 that are connected to the negative-electrode current collector 7a. All positive electrode leads 12 are extended to an upper face side as one end in an axial direction of the wound electrode body 3, and all negative electrode leads 13 are extended to a lower face side as the other end in the axial direction of the wound electrode body 3. Further, in a center hole 3a formed at a center portion of the wound electrode body 3, a center pin 14 formed in a pipe shape is inserted. Then, an upper insulation plate 15 is placed on the upper surface of the wound electrode body 3, and a lower insulation plate 16 is placed on the lower surface of the wound electrode body 3.

The center pin 14 serves as a measure for preventing an internal short circuit (short circuit) from being occured by preventing or inhibiting the crush of the wound electrode body 3 when the abnormal pressure applied on the battery, and further, it serves to move the gas accumulated at the bottom portion of the battery can 2 to the side of the safety valve device 4 of the upper portion. Although the center pin 14 has such important functionality, it is preferable to make an outer diameter thereof as small as possible in order to raise the electrode density of the wound electrode body 3. The center pin 14 is provided with a center hole 14a penetrating at its center portion in its axial direction, and a slit 14b, which is connected to the center hole 14a and continually provided from one end to the other end in its axial direction.

A flexural strength of the center pin 14 is defined so as to have a strength at least 34 N so that the center pin 14 is not crushed by a force equal to 34N or less. A value of the flexural strength is measured assuming that a distance between supporting points for supporting a test strip used for the flexure test is defined as 25 mm. In addition, as the center pin 14, a material such that a Young's modulus E is 100,000 N/mm² or more at a temperature over 600° C. is used. Since the center pin 14 has such a property, even if the internal pressure of the battery can abnormally increased, it is possible to prevent or effectively inhibit the crush of the wound electrode body 3 by the center pin 14.

As described later with a table 1, a stainless steel is suitable for a material of such a center pin 14. However, the material for the center pin 14 is not limited to the examples described above, and it is possible to use the other metal which is rather light and has a higher strength. Thus, when the stainless steel or the like is used as the material for the center pin 14, a flow rate of the gas passing through the center hole 14a can be assured as large as possible by decreasing an outer diameter of the center pin 14 as much as possible and increasing a diameter of the center hole 14a as much as possible.

For example, with regard to specific measurement values of the above described center pin 14, an outer diameter may be 3.5 mm, a wall thickness (or plate thickness) 0.3 mm in a case of the lithium-ion secondary battery of a cylindrical battery of a diameter 18 mm×a height 65 mm. Accordingly, its inner diameter is 2.9 mm. In addition, assuming that the inner diameter of the battery can 2 is A, the outer diameter of the wound electrode body 3 is B, its inner diameter is C, and the outer diameter of the center pin 14 is D, these measurement relations can be set as follows.

As shown in FIG. 4, a ratio among the outer diameter B of the wound electrode body 3, the inner diameter A of the battery can 2, and the outer diameter D of the center pin 14 is defined as B:A:D=0.97:1:0.2 to 0.96:1:0.13. In addition, a ratio between the inner diameter C of the wound electrode body 3 and the outer diameter D of the center pin 14 is defined as C:D=1:0.95 to 1:0.79.

According to the above described measurement relations, even if the wound electrode body 3 is expanded due to the increase of the temperature and the outer diameter thereof is increased, it is possible to minimize the pressure acting on the inner surface of the battery can 2 and to minimize the increase of the internal pressure. Then, combined with making the outer diameter D of the center pin 14 as small as possible, a length of each mixture layer of the positive electrode 6 and the negative electrode 7 may be extended as much as possible. As a result, by making the mixture layer as long as possible, it is possible to increase the entire capacity of the wound electrode body 3.

In the upper insulation plate 15 and the lower insulation plate 16, their outer diameters are slightly smaller than those of the wound electrode body 3, and center holes 15a and 16a penetrating front and rear surfaces of the wound electrode body 3 are disposed at the center portions of the upper insulation plate 15 and the lower insulation plate 16, respectively. Then, all positive leads 12 penetrate the upper insulation plate 15 and the negative leads 13 are concentrated on the lower surface through the outside of the lower insulation plate 16. The above described wound electrode body 3 is stored inside of the battery can 2 together with the upper insulation plate 15 and the lower insulation plate 16. Then, a plurality of negative leads 13, which are grouped on the lower side of the lower insulation plate 16, are combined and fixed on the inner surface of a terminal portion 2a by fixation means such as welding or the like, and are electrically connected.

In the battery can 2, a lower area of the lower insulation plate 16 is communicated with an upper area of the upper insulation plate 15 through the center hole 16a of the lower insulation plate 16, the center hole 14a of the center pin 14, and the center hole 15a of the upper insulation plate 15. On the opening portion of the battery can 2 as the upper area of the upper insulation plate 15, the safety valve device 4 and the terminal plate 5 are superimposed with each other to be fit.

Both of the safety valve device 4 and the terminal plate 5 are formed in a disc, their outer circumference edges are held by a gasket 17 formed in ring shape. With these assembled structure, the opening portion of the battery can 2 is closed. Then, by crimping the vicinity of the opening portion of the battery can 2 through the gasket 17, or performing a laser welding or the like, the opening portion of the battery can 2 is sealed in fluid tightness.

The safety valve device 4 is constructed by including a cleavage valve 18 having a function to release the gas accumulated within the battery to outside when the gas is abnormally generated inside of the battery, and a shut-off valve 19 having a function to shut off the current when the overcharge occurs. The cleavage valve 18 has a cleavage portion that would be cleaved when a pressure more than a predetermined value is applied thereto. The gas inside of the battery is released to outside if the cleavage portion is opened when a pressure more than the predetermined value is applied. In addition, when the excessive current passes through the safety valve device 4, the shut-off valve 19 serves to prevent the current from passing through the safety valve device 4 by shutting off the current circuit. For example, a PTC element or the like may be employed to the shut-off valve 19.

A plurality of positive leads 12 that are extended to the upper side of the upper insulation plate 15 are combined and fixed on the shut-off valve 19 of the safety valve device 4 by fixation means such as welding or the like, and are electrically connected. An inner region of the shut-off valve 19 with respect to the radial direction is shaped in a disk form and expanded to the lower direction. Corresponding to such a structure, an inner region of the terminal plate 5 with respect to the radial direction is also shaped in a disk form as the same way as the above but it is expanded to the upper direction contrary to the shut-off valve 19. On the terminal plate 5, a gas releasing hole 5a is disposed to release the abnormal gas accumulated inside of the battery to outside.

The lithium ion secondary battery 1 having the above described structure is capable of being easily produced, for example, in the following manner. At first, after the positive electrode 6 and the negative electrode 7 that are produced as described above are overlaid in the order of the negative electrode 7, the separator 8, the positive electrode 6, and the separator 9, they are wound for a predetermined number of times and the winding end portion is fixed by the adhesive tape 20 or the like. This completes the production of the wound electrode body 3 that is wound spirally.

The center pin 14 is inserted into the center hole 3a of the wound electrode body 3 and the upper insulation plate 15 and the lower insulation plate 16 are placed above and below the center pin 14, and stored in a space of the battery can 2. Next, a plurality of negative electrode leads 13 are welded on the inner surface of the terminal portion 2a of the battery can 2. In addition, the positive leads 12 are welded on the safety valve device 4. In the next place, the electrolytic solution is injected into the battery can 2. This electrolytic solution may be prepared, for example, by dissolving an electrolytic salt LiPF6 in an organic solvent in which a ethylene carbonate and a methyl ethyl carbonate are mixed at a volume ratio of 5:5 at a density of 1 mol/l.

After that, the safety valve device 4 and the terminal plate 5 are mounted on the gasket 17 for sealing the opening, a surface of which is treated with asphalt. With these assembled structure, the opening portion of the battery can 2 is closed. Next, by crimping the opening of the battery can 2, the safety valve device 4 and the terminal plate 5 are fixed through the gasket 17. This completes the production of the lithium ion secondary battery 1, of which outer shape is a cylinder type.

According to the lithium ion secondary battery 1, for example, if a charge cycle proceeds and the overcharge occurs, the lithium metal separates out on the front face of the negative electrode 7 and the negative electrode 7 becomes thick, so that the outer diameter of the wound electrode body 3 becomes larger. Then, the outer circumference of the wound electrode body 3 hits against the inner surface of the battery can 2, so that each end portion of the outer circumference side of the negative electrode 7 and the positive electrode 6 is pressed and connected to the separators 8 and 9 that are located inner side, respectively.

However, in the case that the measurement relation among the battery can 2, the wound electrode body 3, and the center pin 14 is set within the above described range, even if the wound electrode body 3 is expanded due to rise of temperature, by absorbing the measurement change of the wound electrode body 3 by means of gaps provided between the adjacent members, it is possible to minimize the impact of the measurement change of the wound electrode body 3 when the internal pressure increase. Therefore, it is possible to inhibit the pressure increase inside of the battery and to inhibit the occurence of fluid leak.

In addition, even if the end portion of the negative-electrode current collector 7a at the outer circumference side bursts through the separator 8, which is disposed at the inner side with respect to the radial direction, due to the internal pressure increase and comes into contact with the electrode locating inside, and even if a resultant internal short circuit causes heat generation, only the current collectors are coming into contact and they can diffuse the heat with each other. Accordingly, it is possible to curve the rise of temperature as compared to the case in which the mixture layer comes into contact with the current collector. As a result, it is possible to minimize an impact on the entire battery such as generation of heat and release of fume or the like, thereby enabling to obtain the nonaqueous electrolyte secondary battery with excellent safety.

Further, since the end portion of the negative-electrode current collector 7a of the negative electrode 7 at the outer circumference side is constructed so as to extend further than the end portion of the positive-electrode current collector 6a of the positive electrode 6 at the outer circumference side, it is possible to decrease the negative-electrode active material having no reaction inside the battery and to widen the region having a reaction. Accordingly, an effective battery area may be increased by the amount corresponding to the decreased portion inside of the battery in which no reaction is taking place, and it is possible to enhance the effective use of the inside of the battery, to raise the energy density, and to improve the life duration of charging/discharging cycle.

In the next, test examples of the center pin according to the present invention and a center pin according to the conventional technique will be described. In the test examples, with respect to three center pins in total, namely, one center pin according to the present invention (a test example 1) and two center pins to be compared as the above one center pin (comparative examples 1 and 2), a flexural strength, a weight, and a Young's modulus were measured, respectively. Results are shown in a table 1.

TABLE 1

| | material | flexural | | Young's |
|---|---|---|---|---|
| | of center | strength N | weight g | modulus |
| | pin | (newton) | (gram) | (N/mm²) |
| comparative | copper | 20.58 | 3.82 | 100,000 |
| example 1 | | | | or less |
| comparative | stainless | 372.4 | 1.20 | 150,000 |
| example 2 | steel | | | or larger |
| test | stainless | 44.1 | 0.55 | 150,000 |
| example 1 | steel | | | or larger |

As being obvious from the above test result, in the comparative example 1, the flexural strength is too low, namely, 20.58 N, and further, the Young's modulus is low, namely, 100,000 N/mm² and below. On the contrary, the weight is heavier by a large margin compared to the other materials, namely, 3.82 g. Accordingly, it becomes clear that a copper (Cu) as a material of the center pin is not appropriate in view of each of the flexural strength, the weight, and the Young's modulus.

In addition, in the comparative example 2, the flexural strength is sufficient, namely, 372.4 N, however, the weight is comparatively heavy, namely, 1.20 g. On the other hand, the Young's modulus is high, namely, 150,000 N/mm² or more. Judging these points totally, since the stainless steel (SUS) of the comparative example 2 is slightly heavy as a material of the center pin, it becomes clear that the stainless steel is slightly insufficient as a material of the center pin.

On the contrary, the stainless steel of the test example 1 has a certain degree of the flexural strength, namely, 44.1 N when a distance between support points for supporting a test strip used for the flexure test is defined as 25 mm, and the Young's modulus is high, namely, 150,000 or more. The most advantageous point is that the weight is remarkably light, namely, 0.55 g. As a result, judging these points totally, the stainless steel of the test example 1 has a distinguished characteristic as a material of the center pin that its weight is very light. Therefore, it becomes clear that the stainless steel of the test example 1 is the most excellent material as a material of the center pin.

The first embodiment of the present invention is as described above. However, the present invention is not limited to the above described embodiment. For example, according to the above described embodiment, the cylindrical secondary battery in which the battery can is shaped cylindrically is described, however, as a matter of course, the present invention may be applied to a square secondary battery in which the battery can is shaped in a square such as rectangular and quadrate or the like, and an oval secondary battery in which the battery can is ellipse or oval shape. Thus, The present invention may be embodied in other various forms without departing from the spirit or essential characteristics thereof.

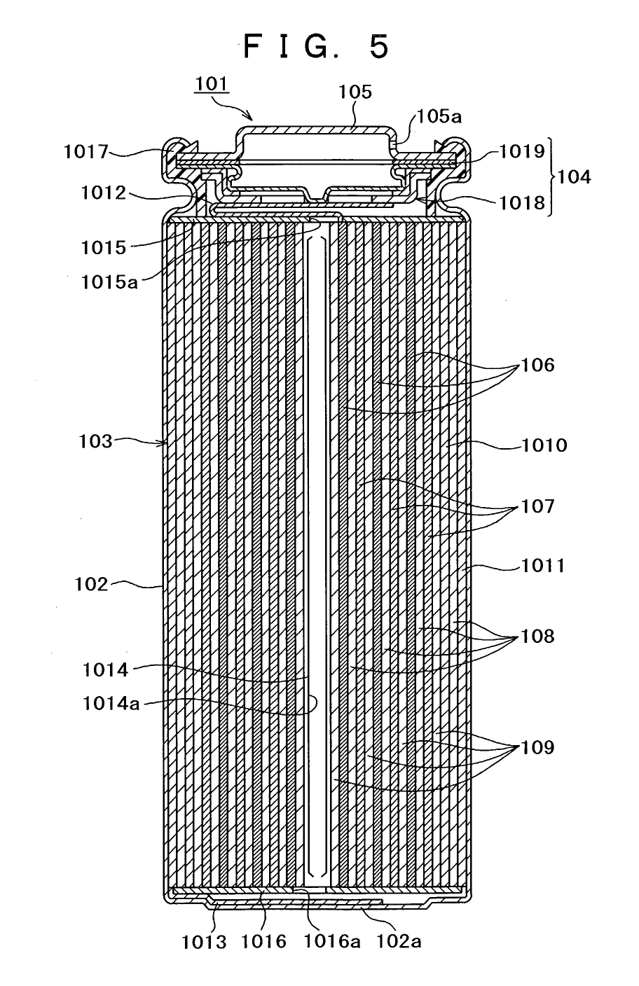

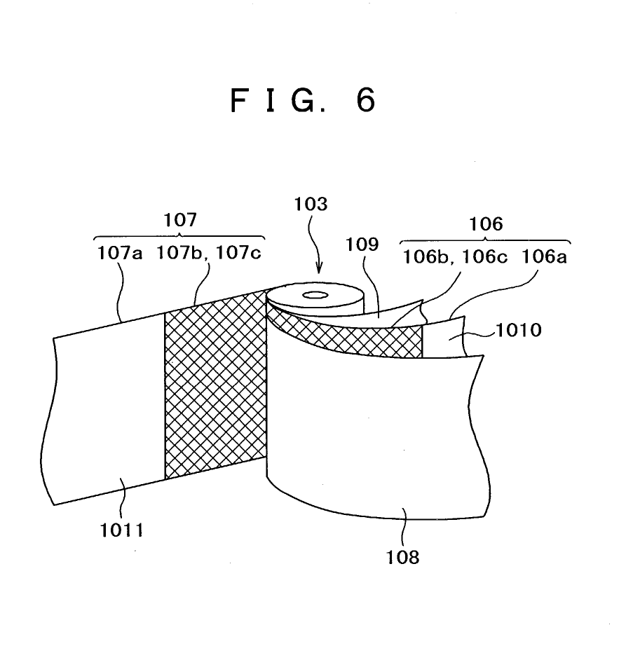

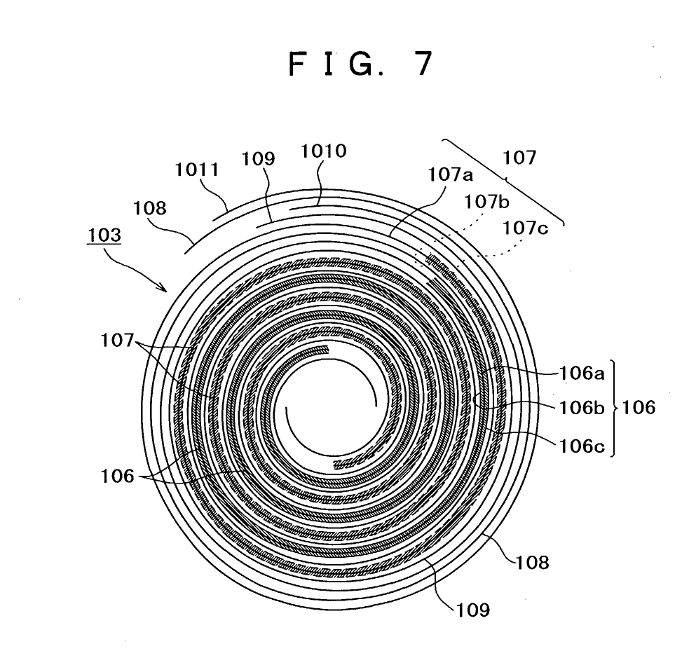

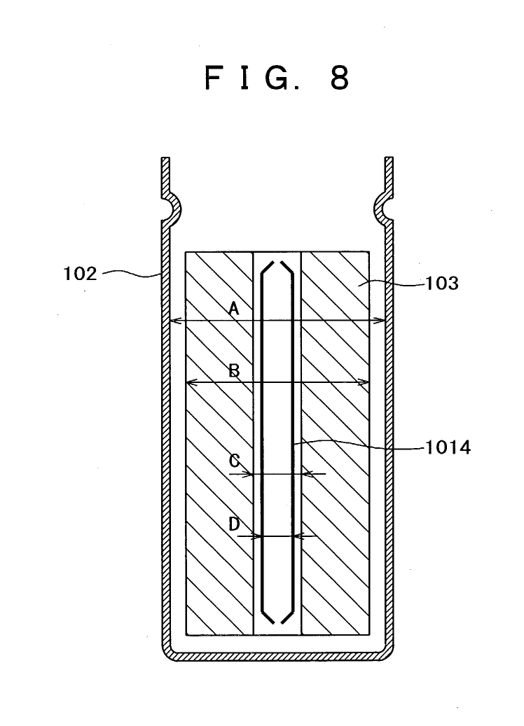

A second embodiment according to the present invention will be described below with reference to FIGS. 5 to 8.

As a nonaqueous electrolyte secondary battery according to the second embodiment of the present invention, for example, a lithium-ion secondary battery may be used. FIG. 5 is a longitudinal sectional view for showing a center portion of the lithium-ion secondary battery. As shown in FIG. 5, a lithium-ion secondary battery 101 may include a cylindrical battery can 102, a wound electrode body 103 that is stored inside of the battery can 102, a safety valve device 104 for preventing abnormal pressure increase and overcharge within the battery, and a terminal plate 105 to close an opening of the battery can 102.

The battery can 102 is formed as a hollow and cylindrical body with a bottom, for example, by a metal having conductivity such as Fe or the like. At the bottom of the battery can 102, a terminal portion 102a is disposed as a result that the center portion thereof is expanded in a circle slightly to the outside. It is preferable that an inner face of the battery can 102 is constructed so as to increase conductivity of the battery can 102, for example, by applying nickel plate thereto or applying an electrically conductive coating thereto. In addition, for example, an outer circumferential surface of the battery can 102 is protected with being covered with an exterior label that is made of a plastic sheet and a paper or the like or applied with an insulation coating.

The wound electrode body 103 that is stored inside of the battery can 102 has a structure as shown in FIGS. 5 to 7. In other words, the wound electrode body 103 is provided with a positive electrode 106 and a negative electrode 107 that are formed in a strip shape and two separators 108 and 109 that are formed in a strip shape as same as these electrodes. One separator 108 is placed between the positive electrode 106 and the negative electrode 107 and the other separator 109 is placed at the opposite side against one separator 108 of the positive electrode 106. The wound electrode body 103 that is wound spirally is constructed by winding a multi-layered body in which four layers of the structural elements described above are overlaid while placing the positive electrode 106 at the inner side.

The positive electrode 106 is constructed by a positive-electrode current collector 106a that is formed in a strip shape and positive-electrode mixture layers 106b, 106c that are applied on both sides of the positive-electrode current collector 106a. As the positive-electrode current collector 106a, for example, an aluminum foil of thickness 20 μm may be used. By evenly applying a positive-electrode mixture slurry on both sides of the positive-electrode current collector 106a, the positive-electrode mixture layers 106b, 106c are formed. In this case, at one end (winding end side) in a longitudinal direction of the positive-electrode current collector 106a, a current collector exposed portion 1010 is formed so that the positive-electrode mixture slurry is not applied across a certain range.

As a positive-electrode active material of the positive-electrode mixture, the following materials may be used. For example, a chalcogen compound of a transition metal containing an alkali metal, particularly, an oxide of an alkali metal and a transition metal is capable of being used. In addition, as a crystal structure of a chemical compound, a laminated chemical compound and a spinel type chemical compound are frequently used. As the laminated chemical compound, the chemical compound represented as LixMO₂ in a general expression may be used. In this case, Li represents a lithium and O₂ represents an oxygen.

In addition, as M, one or more elements selected from a group of transition metal elements, specifically, iron (Fe), cobalt (Co), nickel (Ni), manganese (Mn), copper (Cu), zinc (Zn), aluminum (Al), tin (Sn), boron (B), gallium (Ga), chrome (Cr), vanadium (V), titanium (Ti), magnesium (Mg), calcium (Ca) and strontium (Sr) or the like may be used. Further, it is preferable that M may include one or two kinds elements selected from a group consisting of Fe, Co, Ni and Mn.

The positive-electrode mixture slurry is produced by use of such a positive-electrode active material. For example, it is possible to produce the positive-electrode mixture slurry in such a manner that the positive-electrode mixture is prepared by mixing a powder LiCoO₂ of 86 weight percent, graphite of 10 weight percent as an electrically conductive agent, and a poly(vinylidene fluoride) of 4 weight percent as a binding agent, and this is diffused into N-methyl-2-pyrrolidone.

This positive-electrode mixture slurry is evenly applied on both sides of the positive-electrode current collector 106a so that the positive-electrode current collector exposed portion 1010 is formed at a winding end portion (the end portion of the outer circumference side in the winding direction). Assuming that an outer diameter of the wound electrode body 103 (a diameter of an outer circumferential surface) is defined as d, the length of the positive-electrode current collector exposed portion 1010 is defined as being not less than π(a circular constant)×d, namely, the length at least one lap (one full circle). Thus, after the positive-electrode mixture slurry is applied on both sides of the positive-electrode current collector 106a, the positive-electrode mixture slurry on both sides is dried to be molded with compression by a roller pressing machine, so that the positive electrode 106 is formed in a strip shape.

The negative electrode 107 is constructed by the negative-electrode current collector 107a that is formed in a strip shape as same as the above, and the negative-electrode mixture layers 107b, 107c that are applied on both sides of the negative-electrode current collector 107a. As the negative-electrode current collector 7a, for example, it is possible to use a copper foil of thickness 10 μm. By evenly applying the negative-electrode mixture slurry on both sides of the negative-electrode current collector 107a, the negative-electrode mixture layers 107b and 107c may be formed. In this case, at one end in a longitudinal direction of the negative-electrode current collector 107a (the end portion of the outer circumference side in the winding direction), a negative-electrode current collector exposed portion 1011 is formed so that the negative-electrode mixture slurry is not applied across a certain range.

A negative-electrode active material of the negative-electrode mixture may be, for example, a negative-electrode active material consisting at least one kind of elements selected from alloys, material capable of being chemically combined, and carbonaceous material, those of which are capable of insertion and extraction of lithium. As the negative-electrode active material capable of insertion and extraction of lithium, for example, metals or semiconductors capable of forming alloys or compounds with lithium, or alloys and compounds of these metals and semiconductors may be used.

These metals, alloys or compounds are, for example, represented as a chemical formula DsEtLiu. In this chemical formula, D represents at least one kind among a metal element or a semiconductor element capable of forming an alloy or a compound with lithium. In addition, E represents at least one kind of elements selected from metals and semiconductors other than lithium Li and D. Further, values of S, t and u may be set as s>0, t≧0, and u≧0, respectively.

Specifically, as the metal element or the semiconductor element capable of forming an alloy or a compound with lithium, a metal element of 4B group or a semiconductor element of 4B group is preferable, silicon or tin is more preferable, and silicon is the most preferable. Further, these alloys or compounds thereof is also preferable. Specifically, SiB₄, SiB₆, Mg₂Si, Mg₂Sn, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂ or ZnSi₂ or the like may be used.

In addition, as the other example of the negative-electrode active material capable of insertion and extraction of lithium, a carbonaceous material, a metal oxide, or a polymeric material may be also used. As the carbonaceous material, for example, a nongraphitizable carbon, a glassy carbon, an artificial graphite, a coke class, a graphite class, an organic polymer compound calcined body, a carbon fiber, an activated carbon or a carbon black class or the like may be used. Among these elements, the coke may include a pitch coke, a needle coke or a petroleum coke or the like. In addition, the organic polymer compound calcined body means a polymer member such as a phenol class and a furan class or the like is calcined at an appropriate temperature to be carbonized. Further, as the metal oxide, an iron oxide, a ruthenium oxide, a molybdenum oxide or a tin oxide or the like may be used. In addition, as the polymer material, a polyacetylene or a polypyrrole or the like may be used.

As the nonaqueous electrolyte, a liquid, solid or gel electrolyte or the like may be used, in which the electrolyte is mixed or dissolved in a nonaqueous solvent, a solid electrolyte, a polymer electrolyte and a polymer compound. In this case, as the nonaqueous solvent, for example, a cyclic ester compound such as an ethylene carbonate, a propylene carbonate, a γ-valerolactone and a vinylene carbonate or the like, an ether compound such as a diethoxyethane, a tetrahydrofuran, a 2-methyltetrahydrofuran, and 1,3-dioxane or the like, a chain-type ester compound such as a methyl acetate, a propylene acid methyl or the like, a chain-type carbonate such as a dimethyl carbonate, a diethyl carbonate, and an ethylmethyl carbonate or the like, or 2,4-difluoroanisole, 2,6-difluoroanisole, a 4-bromoveratrole or the like may be used solely or as a mixed solvent of two kinds and more.

In addition, as the polymer material to be used for the gel electrolyte, for example, a polyacrylonitrile and a copolymer of a polyacrylonitrile may be used. As the copolymer monomer (vinyl monomer), for example, a vinyl acetate, a methyl methacrylate, a butyl methacrylate, a methyl acrylate, a butyl acrylate, an itaconic acid, a hydrogenated methyl acrylate, a hydrogenated ethyl acrylate, an acrylic amide, a vinyl chloride, vinylidene fluoride, and a vinylidene chloride, a copolymer of vinylidene fluoride-hexafluoropropylene and a poly-4-fluorination ethylene or the like may be used. Further, an acrylonitrile butadiene rubber, an acrylonitrile butadiene styrene resin, an acrylonitril polyethylene chloride polyethylene propylene diene styrene resin, an acrylonitrile vinyl chloride resin, an acrylonitrile meta acrylate resin, and an acrylonitrile acrylate resin or the like may be used.

Further, as the polymer material to be used for the gel electrolyte, a poly(vinylidene fluoride) and a copolymer of a poly(vinylidene fluoride) may be used. Then, as a copolymer monomer, for example, a hexafluoropropylene and a tetrafluoroethylene or the like may be used. In addition, as polymer material to be used for the gel electrolyte, the above elements may be used solely or as a mixed solvent of two kinds or more.

In order to form the gel electrolyte layer, as the nonaqueous solvent, for example, a cyclic ester compound such as an ethylene carbonate, a propylene carbonate, a butylene carbonate, a vinylene carbonate, a γ-butyl lactone, and a γ-valerolactone or the like, an ether compound such as a diethoxyethane, a tetrahydrofuran, a 2-methyltetrahydrofuran, and 1,3-dioxane or the like, a chain-type ester compound such as a methyl acetate, a propylene acid methyl or the like, a chain-type carbonate such as a dimethyl carbonate, a diethyl carbonate, and an ethylmethyl carbonate or the like, or 2,4-difluoroanisole, 2,6-difluoroanisole, a 4-bromoveratrole or the like may be used solely or as a mixed solvent of two kinds or more.

Further, in the gel electrolyte layer, in the case of using a poly(vinylidene fluoride) as the gel electrolyte, it is preferable that the gel electrolyte composed by a multicomponent system polymer in which a polyhexafluoropropylene and a poly-4-fluorination ethylene or the like are copolymerized is used. This allows a gel electrolyte having a higher mechanical strength to be obtained.

In addition, as the electrolyte salt, for example, a lithium salt such as LiPF₆, LiAsF₆, LiBF₄, LiCIO₄, LiCF₃SO₃, LiN (CnF₂ₙ₊₁SO₂)₂, LiC₄F₉SO₃ or the like may be used solely or as a mixed solvent of two kinds or more. Further, it is preferable that an addition quantity of the electrolyte salt is prepared so that a molar concentraction of a nonaqueous electrolytic solution in the gel electrolyte is 0.8 to 2.0 mol/l in order to obtain a satisfactory ionic conductance.

The negative-electrode mixture slurry is produced by use of such a negative-electrode active material. For example, it is possible to produce the negative-electrode mixture slurry in such a manner that the negative-electrode mixture is prepared by mixing a graphite material powder of 90 weight percent, and a poly (vinylidene fluoride) of 10 weight percent as a binding agent, and this is diffused into N-methyl-2-pyrrolidone. This negative-electrode mixture slurry is evenly applied on both sides of the negative-electrode current collector 107a so that the negative-electrode current collector exposed portion 1011 is formed.

Assuming that an outer diameter of the wound electrode body 103 is defined as d, the length of the negative-electrode current collector exposed portion 1011 is defined as being not less than π×d, namely, the length at least one lap. Thus, after the positive-electrode mixture slurry is applied on both sides of the negative-electrode current collector 107a, the positive-electrode mixture slurry on both sides is dried to be molded with compression by the roller pressing machine, so that the negative electrode 107 is formed in a strip shape.

In addition, as the separators 108 and 109, for example, a polypropylene film with a minute porosity may be used. The thickness of these separators 108 and 109 is about 25 μm, and these separators 108 and 109 are placed between the positive electorde 106 and the negative electrode 107. Then, these elements are overlaid in the order of the negative electrode 107, the separator 108, the positive electrode 106 and the separator 109 to be wound from one end to the other end. Then, by use of an adhesive tape or the like, an end portion at an outer circumference (winding end side) in a winding direction is fixed. This completes the production of the wound electrode body 103 that is wound spirally.

A density of the above described positive electrode 106 (only for the positive-electrode active material of the positive-electrode mixture layers 106b and 106c) may be within the range of 3.40 to 3.60 g/cm³. In addition, a density of the negative electrode 107 (only for the negative-electrode active material of the negative-electrode mixture layers 107b and 107c) may be within the range of 1.55 to 1.80 g/cm³. By using values within such ranges as the electrode density of the positive electrode 106 and the negative electrode 107, it is possible to increase a reliability of the electrode body 103 and to help its electric energy last longer.

The wound electrode body 103 having such a structure is provided with a plurality of positive electrode leads 1012 that are connected to the positive-electrode current collector 106a, and a plurality of negative electrode leads 1013 that are connected to the negative-electrode current collector 107a. As shown in FIG. 5, all positive electrode leads 1012 are extended to an upper face side as one end in an axial direction of the wound electrode body 103, and all negative electrode leads 1013 are extended to a lower face side as the other end in an axial direction of the wound electrode body 103. Further, in a center hole formed at a center port ion of the wound electrode body 103, a center pin 1014 formed in a pipe shape is inserted. Then, an upper insulation plate 1015 is placed on the upper surface of the wound electrode body 103, and a lower insulation plate 1016 is placed on the lower surface of the wound electrode body 103.

A main purpose of the center pin 1014 is to prevent an internal short circuit (short circuit) from being occurred by preventing or inhibiting the crush of the wound electrode body 103 when the abnormal pressure occurs within the battery, and further, it serves to move the gas accumulated at the bottom portion of the battery can 102 to the side of the safety valve device 104 of the upper portion. Further, in order to raise the electrode density of the wound electrode body 103, as a material of the center pin 1014, a material that is light and has a high strength, for example, a stainless steel (for example, SUS304 and SUS430), a nickel steel, and a metal titanium are suitable, however, the material of the center pin 1014 is not limited to these. In the case of using SUS304 as the material of the center pin 1014, a flow rate of the gas passing through the center hole can be assured as large as possible by decreasing an outer diameter of the center pin 1014 as much as possible and increasing a diameter of the center hole as much as possible.

In addition, assuming that the inner diameter of the battery can 102 is defined as A, the outer diameter of the wound electrode body 103 is defined as B, the inner diameter of the wound electrode body 103 is defined as C, and the outer diameter of the center pin 1014 is defined as D, a measurement relation between these may be set as follows. Namely, a ratio among the outer diameter B of the wound electrode body 103, the inner diameter A of the battery can 102, and the outer diameter D of the center pin 1014 is defined as B:A:D=0.97:1:0.2 to 0.96:1:0.17. In addition, a ratio between the inner diameter C of the wound electrode body 103 and the outer diameter D of the center pin 1014 is defined as C:D=1:0.95 to 1:0.79.

According to the above described measurement relations, even if the wound electrode body 103 is expanded due to the increase of the temperature and the outer diameter thereof is increased, it is possible to minimize the pressure acting on the inner surface of the battery can 102 and to minimize the increase of the internal pressure. Then, combined with making the outer diameter D of the center pin 1014 as small as possible, a length of each mixture layer of the positive electrode 106 and the negative electrode 107 is capable of being longer as much as possible. As a result, by making the mixture layer as long as possible, it is possible to increase the entire capacity of the wound electrode body 103.

In the upper insulation plate 1015 and the lower insulation plate 1016, their outer diameters are slightly smaller than those of the wound electrode body 103, and center holes 1015a and 1016a penetrating front and rear surfaces of the wound electrode body 103 are disposed at the center portions of the upper insulation plate 1015 and the lower insulation plate 1016, respectively. Then, all positive leads 1012 penetrate the upper insulation plate 1015 and the negative leads 1013 are concentrated on the lower surface through the outside of the lower insulation plate 1016. The above described wound electrode body 103 is stored inside of the battery can 102 together with the upper insulation plate 1015 and the lower insulation plate 1016. Then, a plurality of negative leads 1013 grouped on the lower side of the lower insulation plate 1016 are combined and fixed on the inner surface of a terminal portion 102a by fixation means such as welding or the like, and are electrically connected.

In the battery can 102, a lower area of the lower insulation plate 1016 is communicated with an upper area of the upper insulation plate 1015 through the center hole 1016a of the lower insulation plate 1016, the center hole 1014a of the center pin 1014, and the center hole 1015a of the upper insulation plate 1015. On the opening portion of the battery can 102 as the upper area of an upper insulation plate 1015, the safety valve device 104 and the terminal plate 105 are superimposed with each other to be fit. Both of the safety valve device 104 and the terminal plate 105 are formed in a disc, their outer circumference edges are held by a gasket 1017 shaped in a ring. With these assembled structure, the opening portion of the battery can 102 is closed. Then, by crimping the vicinity of the opening portion of the battery can 102 through the gasket 1017, or performing a laser welding or the like, the opening portion of the battery can 102 is sealed in fluid tightness.

The safety valve device 104 is constructed by a cleavage valve 1018 having a function to release the gas accumulated within the battery to outside when the gas is abnormally generated inside of the battery, and a shut-off valve 1019 having a function shut off the current when the overcharge occurs. The cleavage valve 1018 has a cleavage portion that would be cleaved when a pressure more than a predetermined value is applied thereto. The gas inside of the battery is released to outside if the cleavage portion is opened when a pressure more than the predetermined value is applied. In addition, when the excessive current passes through the safety valve device 104, the shut-off valve 1019 serves to prevent the current from passing through the safety valve device 4 by shutting off the current circuit. For example, a PTC element or the like may be applied to the shut-off valve 1019.

A plurality of positive leads 1012 that are extended to the upper side of the upper insulation plate 1015 are combined and fixed on the shut-off valve 1019 of the safety valve device 104 by fixation means such as welding or the like, and are electrically connected. An inner region of the shut-off valve 1019 with respect to the radial direction is shaped in a disk form and expanded to the lower direction. Corresponding to such a structure, an inner region of the terminal plate 105 with respect to the radial direction is shaped in a disk form as the same way as the above but it is expanded to the upper direction contrary to the shut-off valve 1019. On the terminal plate 105, a gas releasing hole 105a is disposed to release the abnormal gas accumulated inside of the battery to outside.

The lithium ion secondary battery 101 having the above described structure is capable of being easily produced, for example, in the following manner. At first, after the positive electrode 106 and the negative electrode 107 that are produced as described above are overlaid in the order of the negative electrode 107, the separator 108, the positive electrode 106, and the separator 109, they are wound in a predetermined number of times and the winding end portion is fixed by the adhesive tape or the like. This completes the wound electrode body 103 that is wound spirally.

The center pin 1014 is inserted into the center hole of the wound electrode body 103 and the upper insulation plate 1015 and the lower insulation plate 1016 are placed above and below the center pin 1014, and stored in a space of the battery can 102. Next, a plurality of negative electrode leads 1013 are welded on the inner surface of the terminal portion 102a of the battery can 102. In addition, the positive leads 1012 are welded on the safety valve device 104. Next, the electrolytic solution is injected into the battery can 102. This electrolytic solution may be prepared, for example, by dissolving an electrolytic salt LiPF6 in an organic solvent in which a ethylene carbonate and a methyl ethyl carbonate are mixed at a volume ratio of 5:5 at a density of 1 mol/l.

After that, the safety valve device 104 and the terminal plate 105 are mounted on the gasket 1017 for sealing the opening, a surface of which is treated with asphalt. With these assembled structure, the opening portion of the battery can 102 is closed. In the next place, by crimping the opening of the battery can 102, the safety valve device 104 and the terminal plate 105 are fixed through the gasket 1017. This completes the production of the lithium ion secondary battery 101, of which outer shape is a cylinder type.

According to such a lithium ion secondary battery 101, for example, if a charge cycle proceeds and the overcharge occurs, the lithium metal separates out on the front face of the negative electrode 107 and the negative electrode 107 becomes thick, so that the outer diameter of the wound electrode body 103 becomes larger. Then, the outer circumference of the wound electrode body 103 hits against the inner surface of the battery can 102, so that each end portion of the outer circumference side of the negative electrode 107 and the positive electrode 106 is pressed and connected to the separators 108 and 109 that are located inside, respectively.

However, in the case that the measurement relation among the battery can 102, the wound electrode body 103, and the center pin 1014 is set within the above described range, even if the wound electrode body 103 is expanded due to rise in temperature, by absorbing the measurement change of the wound electrode body 103 by means of gaps provided between the adjacent members, it is possible to minimize the impact of the measurement change of the wound electrode body 103 on the internal pressure increase. Therefore, it is possible to inhibit the pressure increase inside of the battery and to inhibit the occurrence of fluid leak.

Even if the end portion of the negative-electrode current collector 107a at the outer circumference side bursts through the separator 108, which is locating at the inner side with respect to the radial direction, and comes into contact with another electrode located inside due to the increase of the internal pressure, the negative-electrode current collectors 107a of the same negative electrode type come into contact with each other. As a result, the internal short circuit does not occur and it is possible to prevent the occurrence of a malfunction due to the internal short circuit. Further, even if the end portion of the positive-electrode current collector 106a at the outer circumference side bursts through the separator 109, which is locating at the inner side with respect to the radial direction, and comes into contact with the negative-electrode current collectors 107a, and even if the short circuit occurs and heat is generated, only the current collectors are in contact with each other and they can diffuse the heat with each other. Accordingly, it is possible to curve the rise of temperature as compared to the case in which the mixture layer is involved. As a result, it is possible to minimize the damage on the entire battery such as generation of heat and release of fume or the like, and thereby enabling to obtain the nonaqueous electrolyte secondary battery with excellent safety.

Further, since the end portion of the negative-electrode current collector 107a of the negative electrode 107 at the outer circumference side is constructed so as to extend further than the end portion of the positive-electrode current collector 106a of the positive electrode 106 at the outer circumference side, it is possible to decrease the negative-electrode active material having no reaction and to widen the region having a reaction. Accordingly, an effective battery area may be increased by the amount corresponding to the decreased portion inside of the battery in which no reaction is taking place, and it is possible to enhance the effective use of the inside of the battery, to raise the energy density, and to improve the life duration of charging/discharging cycle.

In the next, test examples according to the present invention will be described. With respect to the lithium ion secondary batteries of nine samples in total, the test was carried out under conditions as described in a table 2.

TABLE 2

| | | | Outer | | | | |
|---|---|---|---|---|---|---|---|
| | | | diameter/ | | | | |
| | Positive | Negative | inner | | | | |
| | electrode | electrode | diameter of | Battery | | | |
| Sample | density | density | center pin | capacity | | Cycle | Total |
| number | (g/cm³) | (g/cm³) | (mm) | (mAh) | Safety | property | Judgement |
| 1 | 3.40 | 1.55 | 3.5/2.7 | 1650 | ⊚ | ◯ | f |
| 2 | 3.45 | 1.65 | 3.5/2.7 | 1900 | ⊚ | ⊚ | a |
| 3 | 3.50 | 1.68 | 3.5/2.7 | 2100 | ⊚ | ⊚ | a |
| 4 | 3.50 | 1.68 | 3.0/2.2 | 2130 | ⊚ | ⊚ | a |
| 5 | 3.50 | 1.68 | 2.5/1.7 | 2150 | Δ | ◯ | f |
| 6 | 3.55 | 1.70 | 3.5/2.7 | 2200 | ⊚ | ⊚ | a |
| 7 | 3.60 | 1.78 | 3.5/2.7 | 2400 | ◯ | ◯ | f |
| 8 | 3.60 | 1.78 | No pin | 2400 | X | Δ | f |
| 9 | 3.65 | 1.85 | 3.5/2.7 | 2500 | ◯ | X | f |

Evaluation:
⊚ = excellent,
◯ = good,
Δ = fair,
X = poor
Total judgment:
a = accepted,
f = failed

As a result, the samples numbered as 2, 3, 4 and 6 were evaluated as accepted in a total judgement, and other samples numbered as 1, 5, 7 to 9 were failed in the total judgement. These evaluations depend on the following reason. In other words, in any case, four samples evaluated as accepted in the total judgment are evaluated as excellent (⊚) in safety and a cycle property.

On the contrary, the secondary battery of the sample number 1 is not accepted since the judgment of the cycle property is good (◯). However, according to the judgement of accepted or failed, it is not judged whether or not the secondary battery of the sample number 1 is a defective good, but, the secondary battery of the sample number 1 is compared as a secondary battery having an ideal capability (i.e., both of the safety and the cycle property are excellent). Accordingly, the secondary battery of the sample number 1 involves no problem in actual use.

Further, the secondary battery of the sample number 5 is not accepted since the judgment of the safety is fair (Δ) and the judgment of the cycle property is good (◯). The secondary battery of the sample number 7 is not accepted since the judgment of both of the safety and the judgment of the cycle property is good (◯). Further, the both of the secondary battery of the sample number 8 and that of the sample number 9 are not accepted since the judgment of the safety of the sample number 8 is poor (×) and the judgment of the cycle property of the sample number 9 is poor (×).

According to these test results, by constructing the secondary battery as the above described embodiments of the present invention, even in the case that the electrode bursts through the separator to contact the adjacent electrode, the same electrodes contact to each other. As a result, it is possible to prevent or effectively inhibit generation of the internal short circuit, and further, it is possible to raise the energy density by increasing the effective battery areas.

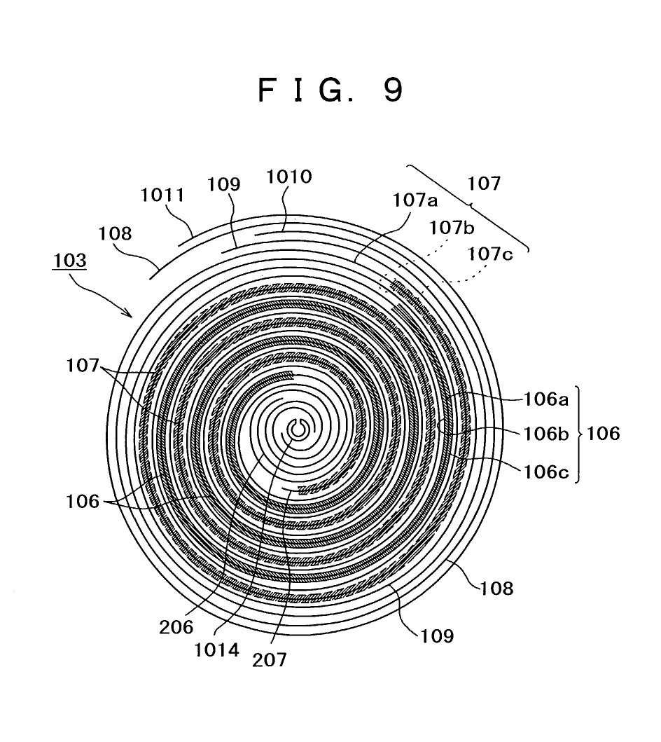

Further, in the second embodiment of the present invention described above, it is preferable that, at the innermost circumference, the positive electrode 106 and the negative electrode 107 do not contact to an outer surface of the center pin 1014. Accordingly, as shown in FIG. 9, a positive electrode current collector exposed portion 206 and a negative electrode current collector exposed portion 207, in which no mixture material is coated, may be provided at end portions of the innermost circumference of the positive electrode 106 and the negative electrode 107, respectively. For example, the negative electrode current collector exposed portion 207 of about 3 mm may be provided at the end portion of the negative electrode 107, and the positive electrode current collector exposed portion 206 of about an length of one circle may be provided at the end portion of the positive electrode 106.

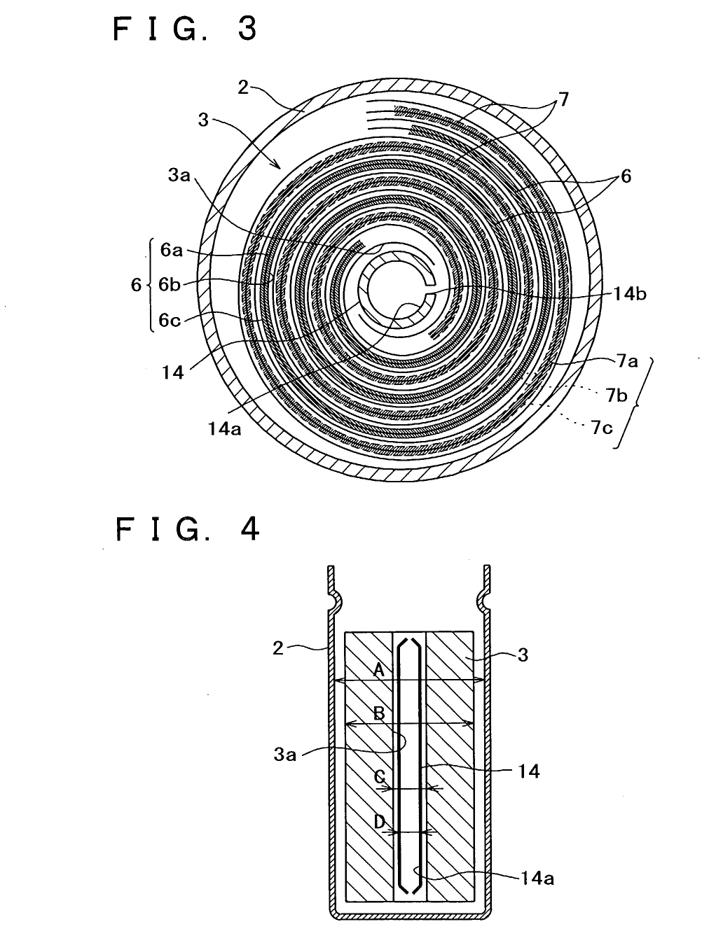

Although, in the second embodiment described above, the negative electrode current collector exposed portion 1011 is placed at the outermost circumference to contact to an inner surface of the battery can 2, the present invention is not limited only to such specific arrangement. For example, in the configuration shown in FIG. 9, the separator may be placed at the outermost circumference to contact to the inner surface of the battery can 2 as in the first embodiment described above (see FIG. 3). In this example, starting from the outermost circumference to the inner direction, the separator, the negative electrode 107, the separator and the positive electrode 106 may be placed in order of mention. According to such arrangement, it is possible to prevent the positive electrode 106 and the negative electrode 107 from contacting the inner surface of the battery can 2.

Alternatively, in the above described arrangement in which the separator is provided at the outermost circumference so as to contact to the inner surface of the battery can 2, current collector exposed portions may be provided for both the positive electrode 106 and negative electrode 107 as in the outermost circumference portion of the second embodiment described above. For example, the current collector exposed portions, on which have no mixture is coated, may be placed at the respective end portions of electrodes and extended over about one full circle or more. It is preferable to have the end part of the negative electrode current collector exposed portion positioned at the outermost circumference is extended further than the end part of the positive electrode current collector exposed portion. For example, terminal end parts of respective constructional elements (layers) may be placed in the following order, where S(oc), S(be), CCE(−), CCE(+) are the terminal ends of the outermost circumference separator, another separator placed in between the positive and negative electrodes, the negative electrode current collector exposed portion and the positive electrode current collector exposed portion.

S(oc)≈S(be)>CCE(−)>CCE(+)

Furthermore, it is preferable to have the center pin 1014 with the axial length equal to or approximately equal to the width of the positive electrode current collector 106a.

While the present invention has been particularly shown and described with reference to preferred embodiments according to the present invention, it will be understood by those skilled in the art that any combinations or sub-combinations of the embodiments and/or other changes in form and details can be made therein without departing from the scope of the invention.

What is claimed is:

1. A nonaqueous electrolyte secondary battery, comprising:
a wound electrode body that is structured by spirally winding electrodes with a separator in between, said electrode having a strip shape and being formed by forming a mixture layer on a current collector having a strip shape;
a hollow cylindrical center pin that is inserted into a center hole of said wound electrode body; and
a battery can, in which said wound electrode body having said center pin inserted therein is stored;
wherein said center pin is formed to have a strength in such a way that said center pin does not crash by a force equal to 34N or less.

2. The nonaqueous electrolyte secondary battery according to claim 1,
wherein said electrode comprises a positive electrode, in which a positive-electrode mixture layer is formed on a positive-electrode current collector; and a negative electrode, in which a negative-electrode mixture layer is formed on a negative-electrode current collector and stacked on said positive electrode with having said separator in between; and
an end portion of said separator at an outer circumference side in a winding direction is elongated further than said positive electrode and said negative electrode, thereby preventing said positive electrode or said negative electrode locating at the outermost circumference to contact an inner surface of said battery can.

3. The nonaqueous electrolyte secondary battery according to claim 1,
wherein said electrode comprises a positive electrode, in which a positive-electrode mixture layer is formed on a positive-electrode current collector; and a negative electrode, in which a negative-electrode mixture layer is formed on a negative-electrode current collector and stacked on said positive electrode having said separator in between; and
an end portion of said separator at an inner circumference side in a winding direction is elongated further than said positive electrode and said negative electrode, thereby preventing said positive electrode or said negative electrode locating at the innermost circumference to contact said inner surface of said center pin.

4. The nonaqueous electrolyte secondary battery according to claim 1,
wherein said electrode comprises a positive electrode, in which a positive-electrode mixture layer is formed on a positive-electrode current collector; and a negative electrode, in which a negative-electrode mixture layer is formed on a negative-electrode current collector and stacked on said positive electrode having said separator in between; and
said positive electrode and said negative electrode are formed to be substantially the same length, and said negative electrode is placed to be outside of said positive electrode so as that the end portion of said negative electrode at the outer circumference side in the winding direction contacts an inner surface of said battery can.

5. The nonaqueous electrolyte secondary battery according to claim 1,
wherein said electrode comprises a positive electrode, in which a positive-electrode mixture layer is formed on a positive-electrode current collector; and a negative electrode, in which a negative-electrode mixture layer is formed on a negative-electrode current collector and stacked on said positive electrode having said separator in between; and
said positive electrode is placed to be at the inner side of said negative electrode, and the end portion of said positive-electrode current collector at the inner circumference side in the winding direction is elongated so that a portion in which said positive-electrode mixture layer is not formed contacts an outer surface of said center pin.

6. The nonaqueous electrolyte secondary battery according to claim 1,
wherein said center pin is formed with a material, of which Young's modulus of the center pin at a temperature more than 600° C. is equal to 100,000 N/mm² or larger.

7. A nonaqueous electrolyte secondary battery, comprising:
a wound electrode body that is structured by spirally winding electrodes with a separator in between, said electrode having a strip shape and being formed by forming mixture layers on both sides of a current collector having a strip shape; and
a battery can, in which said wound electrode body is stored;
wherein said wound electrode body further comprises a current collector exposed portion in which said mixture layers are not formed on neither side of the surfaces of said current collector, said current collector exposed portion being provided to start at the end portion of said electrode at the outer circumference side in the winding direction and extend over a range of at least one lap from an end portion of said current collector having said mixture layers on both sides.

8. The nonaqueous electrolyte secondary battery according to claim 7,
wherein said electrode comprises a positive electrode, in which a positive-electrode mixture layer is formed on a positive-electrode current collector; and a negative electrode, in which a negative-electrode mixture layer is formed on a negative-electrode current collector and stacked on said positive electrode having said separator in between; and
said negative electrode is placed to be at the outside of said positive electrode, and an end portion of said negative-electrode current collector is elongated further than an end portion of said positive-electrode current collector.

9. The nonaqueous electrolyte secondary battery according to claim 7 or claim 8,
wherein a length of said current collector exposed portion is equal to πd or larger, if an outer diameter of said wound electrode body is defined as d.

10. The nonaqueous electrolyte secondary battery according to claim 7 or claim 8,
wherein a center pin formed as a hollow cylinder is inserted in a winding center portion of said wound electrode body.

11. The nonaqueous electrolyte secondary battery according to claim 10,
wherein said center pin is formed to have a strength in such a way that said center pin does not crush by a force equal to 34N or less.

12. The nonaqueous electrolyte secondary battery according to claim 1, 2, 3, 4, 5 or 11,
wherein a ratio among an outer diameter of said wound electrode body, an inner diameter of said battery can and an outer diameter of said center pin is 0.97:1:0.2 to 0.96:1:0.13, and a ratio between an inner diameter of said wound electrode body and said outer diameter of said center pin is 1:0.95 to 1:0.79.

13. The nonaqueous electrolyte secondary battery according to claim 8,
wherein an electrode density of said positive electrode is 3.40 to 3.60 g/cm³, and an electrode density of said negative electrode is 1.55 to 1.80 g/cm³.

14. The nonaqueous electrolyte secondary battery according to claim 10,
wherein a ratio among an outer diameter of said wound electrode body, an inner diameter of said battery can and an outer diameter of said center pin is 0.97:1:0.2 to 0.96:1:0.13, and a ratio between an inner diameter of said wound electrode body and said outer diameter of said center pin is 1:0.95 to 1:0.79.
